(19) United States
(12) Patent Application Publication
(10) Pub. No.: US 2021/0201390 A1
(43) Pub. Date: Jul. 1, 2021

(54) INFORMATION PROCESSING APPARATUS, INFORMATION PROCESSING METHOD AND COMPUTER-READABLE NON-TRANSITORY RECORDING MEDIUM

(71) Applicant: TOYOTA JIDOSHA KABUSHIKI KAISHA, Toyota-shi (JP)

(72) Inventors: Tatsuya MATSUNAMI, Nisshin-shi (JP); Atsuko YAMANAKA, Toyota-shi (JP); Kunihiro TSUNEKAWA, Toyota-shi (JP); Sokfan YEE, Toyota-shi (JP); Masahiro TANAKA, Toyota-shi (JP); Shuichiro TAKAHASHI, Okazaki-shi (JP); Satoshi NONOYAMA, Toyota-shi (JP); Tokuyuki NISHIKAWA, Toyota-shi (JP); Hikaru SATOU, Okazaki-shi (JP)

(73) Assignee: TOYOTA JIDOSHA KABUSHIKI KAISHA, Toyota-shi (JP)

(21) Appl. No.: 17/130,594

(22) Filed: Dec. 22, 2020

(30) Foreign Application Priority Data
Dec. 27, 2019 (JP) 2019-239074

(51) Int. Cl. G06Q 30/06; G06Q 10/02; G06Q 50/30

(52) U.S. Cl. CPC G06Q 30/0645; G06Q 50/30; G06Q 10/02

(57) ABSTRACT

The present disclosure makes it possible to further enhance the convenience of a vehicle rental service. Control unit of information processing apparatus performs obtaining of a purpose of a user reserving utilization of a vehicle from the user, specifying, from among the at least one of the deposit items deposited from the user, an item of a use that matches the obtained purpose of the user, and providing to the user information indicating that a vehicle to be assigned to the user and loaded with the specified item is available.

### CROSS-REFERENCE TO RELATED APPLICATION

This application claims the benefit of Japanese Patent Application No. 2019-239074, filed on Dec. 27, 2019, which is hereby incorporated by reference herein in its entirety.

### BACKGROUND

The present invention relates to information processing apparatus, information processing method and programs.

Patent Document 1 discloses a rental car management system including a vehicle-mounted device mounted on a rental car, a company server managed by a rental car company, and a network connecting these devices to each other.

[Patent Document 1] JP-A-2007-032134

### SUMMARY

One aspect of the present invention is to further enhance the convenience of the vehicle rental service.

One aspect of an embodiment is illustrated by an information processing apparatus comprising a controller illustrated by a control unit. The control unit executes obtaining of purpose of a user reserving utilization of a vehicle from the user, specifying, from at least one of the deposit items deposited from the user, an item of a use that matches the obtained purpose of the user, and providing information to the user indicating that the vehicle to be assigned to the user and loaded with the specified item is available. Another aspect of an embodiment is exemplified by an information processing method executed by at least one computer such as information processing apparatus. Still other aspects of an embodiment of a present disclosure are exemplified by a computer-readable non-transitory recording medium recording a program for causing at least one computer, such as information processing apparatus, to execute the programs.

According to the present information processing apparatus, the convenience of the vehicle rental service can be further improved.

### BRIEF DESCRIPTION OF THE DRAWINGS

FIG. 1 is a conceptual diagram of a system according to an embodiment of the present invention;

FIG. 2 is a block diagram schematically illustrating the configuration of the system of FIG. 1, in particular, a diagram showing the configuration of running unit;

FIG. 3 is a block diagram schematically showing the configuration of the system of FIG. 1, and particularly shows the configuration of the server apparatus;

FIG. 4 is a block diagram schematically showing the configuration of the system of FIG. 1, and particularly shows the configuration of the user apparatus;

FIG. 5A is an illustration of an item database information database in the system of FIG. 1;

FIG. 5B is an illustration of an item database information database in the system of FIG. 1;

FIG. 6 is an example of a user's schedule information in the system of FIG. 1;

FIG. 7 is a flowchart of the control unit of the server apparatus in the system of FIG. 1;

FIG. 8 is a further flow chart of the control unit of the server device in the system of FIG. 1.

### DETAILED DESCRIPTION

The present embodiment exemplifies an information processing apparatus including a control unit. The control unit executes obtaining a purpose of a user reserving utilization of a vehicle from the user, obtaining, an item of use matching the purpose of the user, the item obtained from the at least one deposit items deposited from the user, and providing information indicating to the user that the vehicle to be assigned to the user and loaded with the specified item is capable of utilization to the user.

Information processing apparatus can obtain purpose of the user, for example, on the basis of information of reserving utilization of the vehicle. As a result, information processing apparatus can specify an item of a use that matches the obtained purpose of the user. The purpose of the user is a character string, a keyword, or the like corresponding to purpose of travel intended by the user when the user rides on the vehicle and travels by the vehicle. A use is a character string, a keyword, or the like indicating a use of an item. By associating the purpose of the user and the use, and further associating the use and the item, information processing apparatus can specify the item of the use that fits the purpose of the user. Then, it is possible to notify the user that the specified item can be loaded on the vehicle to be assigned to the user and provided to the user. With such a process, information processing apparatus can manage items and provide it to the user together with the vehicles so that the item deposited by the user can be appropriately utilized to the user in response to the purpose of the user.

Hereinafter, referring to the drawings, an information processing apparatus according to an embodiment of the present disclosure, an information processing method in a control unit of information processing apparatus, and programs will be described.

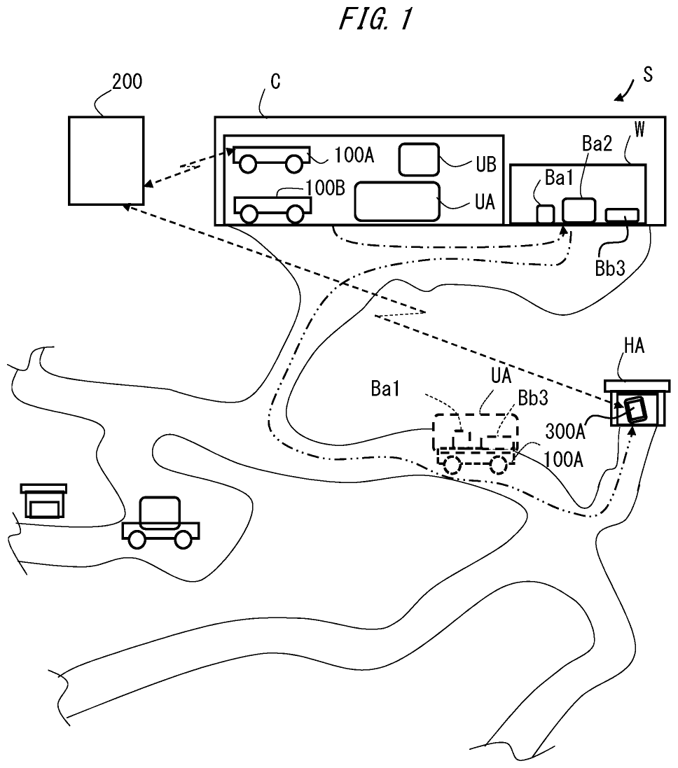

FIG. 1 conceptually exemplifies a vehicle rental system S according to an embodiment of the present invention (hereinafter, simply referred to as system S). FIG. 1 conceptually illustrates a scene in the system S. System S may also be referred to as a dispatch system.

The system S includes a running unit 100 (100A.), a server apparatus 200, and a user apparatus 300 (300A.). In FIG. 1, the standby location of cabin unit U (UA, UB.) and the standby location of running unit 100 are integrated into the center C. The warehouse W that stores item is also integrated in center C. The server apparatus 200 is located away from the center C. However, it may be provided separately from the standby location of cabin unit U and the standby location of running unit 100. The warehouse W storing items may be fully integrated into the center C or completely independent of the center C. The server apparatus 200 may be provided in the center C.

Here, running unit 100 is a mobile unit that can travel based on an operation command from the server device 200. Server device 200 is an information processing apparatus and is a computer on network N. The server device 200 is configured to communicate with each of running unit 100 via the network N and cooperates with information processing apparatus 102 of running unit 100 via the network N. For example, in FIG. 1, only running unit 100A and 100B of the plurality of running unit 100 (100A.) are illustrated. However, this does not limit the number of running unit 100, which may be more than one or any number.

The server device 200 can communicate with other server devices via the network N. In addition to being configured to be able to communicate with each of running unit 100, the server apparatus 200 is also configured to be able to communicate with each of the user apparatuses 300 via the networks N.

User device 300 is configured to be able to communicate with server device 200 via network N. The user device 300 is also configured to be able to communicate with running unit 100 via the network N. For example, FIG. 1 shows only the user device 300A among the multiple user devices 300 (300A, . . . ). However, this does not limit the number of user devices, which may be any number.

Running unit 100 is a kind of autonomous traveling vehicles here, also called Electric Vehicle (EVs) pallets. Running unit 100 is configured as a mobile body capable of automatic operation and unmanned operation. In S, running unit 100 may have various sizes and configurations. Running unit 100 may also not necessarily be a fully autonomous vehicle capable of running. For example, running unit 100 may be a vehicle driven by a person or a vehicle driven with the auxiliary of a person.

The server device 200 is, here, for example, a device for instructing the operation to running unit 100. For example, the server device 200 provides, i.e., transmits, to running unit 100 an operation command including the travel schedule of running unit 100.

Each component of the system S of FIG. 1 is described in detail below. First, running unit 100 is described.

Each running unit 100 has the same connectivity structure and can be connected to a various cabin unit U described below. Examples of a running unit 100 include a normal tire and a snow tire for snow roads. Here, a running unit 100A comprises a snow tire, and a running unit 100B comprises a normal tire.

The running unit 100 can be run alone and is configured to disconnectably or separably a connect cabin unit U (UA, UB, . . . ). In FIG. 1, a broken line illustrates a running unit 100A in which a cabin unit UA is mounted on and connected to an upper portion of the running unit 100A. The cabin unit U is not limited to being mounted on and connected to the running unit 100, and may be, for example, a unit pulled by the running unit 100.

The cabin unit U has a cabin and is configured to allow an item to be loaded. Here, in addition, a person can ride on the cabin unit U. The cabin unit U does not have to be configured to be ridden by a person. However, the cabin unit U is preferably configured for a human ride. The cabin unit U has, for example, chairs. FIG. 1 illustrates two cabin units UA, UB. The cabin unit UA is larger than the cabin unit UB and can carry more or larger items. Here, each of cabin units U (UA, UB, . . . ) has various sizes and the same connecting structure, can be connected to the same running unit 100.

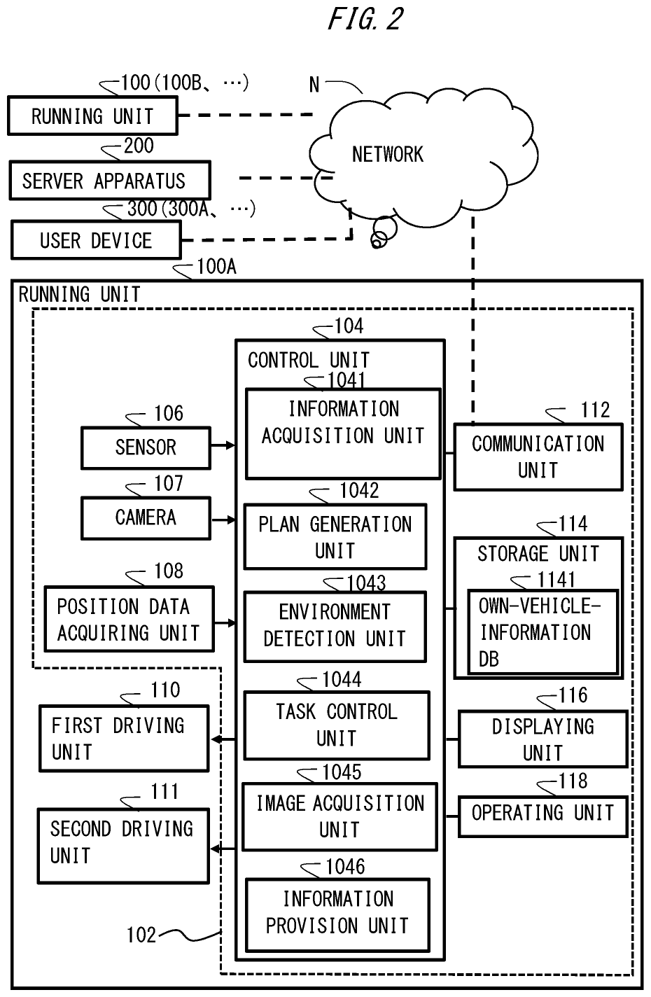

FIG. 2 is a block diagram schematically illustrating the configuration of the system S including the running unit 100, the server apparatus 200, and the user apparatus 300, and in particular, FIG. 2 is a block diagram illustrating the configuration of a running unit 100A. FIG. 2 shows a configuration of the running unit 100A as an exemplary running unit 100. The other running unit 100 (100B.) similarly includes elements included in the configuration of the running unit 100A described below, for example, an information processing apparatus 102.

The running unit 100A of FIG. 2 comprises an information processing apparatus 102 which has a control unit 104 substantially responsible for its function. The running unit 100 A can travel according to an operation command acquired from the server device 200. Specifically, the running unit 100A travels with an appropriate method while sensing the periphery of the vehicle based on the operation command acquired via the network N.

The running unit 100 A further includes: a sensor 106; a camera 107; a position data acquiring unit 10; a first driving unit 110; a second driving unit 111; a communication unit 112; a storage unit 114; a displaying unit 116; an operating unit 118. The running unit 100 A operates with electric power supplied from a battery.

The sensor 106 is a device that senses around vehicles and typically includes stereo cameras, laser scanners, Light Detection and Ranging, Laser Imaging Detection and Ranging (LIDAR), radars, and the like. Information acquired by the sensor 106 is sent to the control unit 104. The sensor 106 includes sensors for autonomous vehicles to perform autonomous travel. The sensor 106 includes cameras mounted on the body of running unit 100A. For example, the cameras may be photographic devices using image sensors such as Charged-Coupled Devices (CCDs), Metal-Oxide-Semiconductor (MOSs), or Complementary Metal-Oxide-Semiconductor (CMOS).

When the cabin unit U is connected to the running unit 100A, the camera 107 is a photographing device for photographing the inside of the connected cabin unit U. The camera 107 is not limited to being provided in running unit 100A, but may be provided in the cabin unit U connected thereto. When the cabin unit U is connected to the running unit 100A, camera 107 is ready to take pictures of the interior of cabin unit U, and transmits the photographed images to the control unit 104. For example, when the cabin unit U is connected to running unit 100A, camera 107 is located at a position where the inside of cabin unit U can be photographed in running unit 100A. When the cabin unit U is connected to the running unit 100A, camera 107 is activated and can transmit captured image data. Although camera 107 has an automated-shooting function, it may be operated by an operator or the like loading items into the cabin unit U.

The position data acquiring unit 10 is a unit for obtaining the present position of running unit 100A. The position data acquiring unit 10 consists of a Global Positioning System (GPS) receiver, etc. A GPS receiver as a satellite signal receiver receives signals from multiple GPS satellites. Each GPS satellite is an artificial satellite orbiting around the Earth. Satellite positioning systems, or Navigation Satellite System, are not limited to GPSs. Position information may be detected based on signals from various satellite positioning systems. NSSs are not limited to global navigation satellite systems and may include quasi-zenith satellite systems (Quasi-Zenith Satellite System), for example “Galileo” in Europe or “Michibiki” in Japan, operated integrally with GPS. The position data acquiring unit 10 may include a receiver for receiving radio waves from a transmitter such as beacons. In this case, a plurality of transmitters may be arranged on the side of a road or the like to periodically emit radio waves of a specific frequency and/or signal type. Position information sensing mechanisms of the position data acquiring unit 10 are not limited to these techniques.

The control unit 104 is a computer that controls the running unit 100A based on information acquired from the sensor 106, the position data acquiring unit 10, or the like. The control unit 104 is an exemplary control unit for controlling the running of running unit 100A, the connecting and disconnecting of the cabin unit U to the running unit 100A, and the like.

The control unit 104 includes a CPU and a main storage unit, and executes information processing programmatically. The CPU is also referred to as a processor. The main storage unit of the control unit 104 is an exemplary main storage device. The CPU in the control unit 104 executes a computer program that is executably expanded in the main storage unit and provides various functions. The main storage unit in the control unit 104 stores a computer program and/or data executed by the CPU. The main storage unit in the control unit 104 is Dynamic Random Access Memory (DRAM), Static Random Access Memory (SRAM), Read Only Memory (ROMs), etc.

The control unit 104 is connected to storage unit 114. The storage unit 114 is a so-called external storage unit, which is used as a storage area for assisting the main storage unit of control unit 104, and stores computer programs and/or data to be executed by the CPUs of the control unit 104. The storage unit 114 may be hard disk drives, Solid State drives, etc.

The control unit 104 has an information acquisition unit 1041, a plan generation unit 1042, an environment detection unit 1043, a task control unit 1044, an image acquisition unit 1045, and an information provision unit 1046 as functional modules. The respective functional modules are realized by executing programs stored in the main storage unit and/or the storage unit 114 by the control unit 104, that is, the CPUs thereof.

The information acquisition unit 1041 acquires information such as an operation command including a travel schedule from the server device 200. The operation command may include information about connecting and disconnecting the cabin unit U to the running unit 100A. The information acquisition unit 1041 acquires information of the vehicle periodically or irregularly and stores it in own-vehicle-information database 1141 of the storage unit 114.

The plan generation unit 1042 generates an operation plan of its own vehicle based on an operation command acquired from the server device 200, and particularly based on information of the travel plan included therein. The operation schedule generated by the plan generation unit 1042 is transmitted to a later-described task control unit 1044. In the present embodiment, the operation schedule is data defining a route along which the running unit 100A runs, scheduled dates and times at respective points of the route, and processing to be performed by the running unit 100A in some or all of the routes. Examples of the data included in the operation plan include, for example, the following.

(1) Data Representing the Route Traveled by the Vehicle by a Set of Road Links

The route along which the vehicle travels may be automatically generated based on a given departure point and a destination point, for example, by referring to the map data stored in the storage unit 114 and based on information of the travel plan included in the operation command. The route may also be generated by utilization of external services.

(2) Data Representing the Processing to be Performed by the Vehicle at a Point on the Route

The processes to be performed by the vehicle on the route include, but are not limited to, connecting and/or disconnecting the cabin unit U, for example.

the environment detection unit 1043 detects an environment around the vehicle based on the data acquired by the sensor 106. The targets of detection are, for example, but are not limited to, the number and location of lanes, the number and location of vehicles present around the own vehicle, the number and location of obstacles present around the vehicle (e.g., pedestrians, bicycles, structures, buildings, etc.), the structure of the road, road signs, and the like. Any object of detection can be used as long as it is necessary to perform autonomous running. the environment detection unit 1043 may also track the detected object. For example, the relative velocity of the object may be obtained from the difference between the coordinates of the object detected 1 step earlier and the coordinates of the present object. The data on the environment (hereinafter referred to as environment data) detected by the environment detection unit 1043 is transmitted to the task control unit 1044 (to be described later).

The task control unit 1044 controls the operation of the first driving unit 110 and the operation of the second driving unit 111 of its own vehicle based on the operation plan generated by the plan generation unit 1042, the environmental data generated by the environment detection unit 1043, and the position information of its own vehicle acquired by the position data acquiring unit 10. For example, the task control unit 1044 travels along a predetermined route and causes the vehicle to travel so that obstacles do not enter a predetermined safety area centered on the vehicle. As a method for autonomously driving a vehicle, a known method can be adopted. The task control unit 1044 also performs tasks other than driving based on driving plans generated by the plan generation unit 1042. The tasks may include connecting and/or disconnecting cabin unit U.

When the cabin unit U is connected to the running unit 100A, the image acquisition unit 1045 acquires images of the cabin of cabin unit U from camera 107. This image may be a still image or a moving image. Image acquisition unit 1045 stores the acquired images in the own-vehicle-information database 1141. Here, the image acquisition unit 1045 is activated when an input is received from the operating unit 118 and activates camera 107 to acquire the image via camera 107. The image acquisition unit 1045 acquires a video from camera 107 and may acquire a still image with camera 107 when it recognizes with the image recognition technique that an item has been loaded in the cabin of cabin unit U. The image acquisition unit 1045 stores the acquired image in the own-vehicle-information database 1141 and provides the image to the server device 200 via the information provision unit 1046 described below.

The information provision unit 1046 provides information of the own vehicle, for example, information stored in the own-vehicle-information database 1141, to the server device 200. The provision of information refers to transmitting of information. This provision may be made periodically and may be made irregularly. The images acquired by the image acquisition unit 1045 are provided to the server device 200 via the information provision unit 1046.

The first driving unit 110 is a device for driving the running unit 100A based on a command generated by the task control unit 1044. the first driving unit 110 includes, for example, motors, inverters, brakes, steering mechanisms, secondary batteries, and the like for driving the wheels.

The second driving unit 111 is a unit for connecting and/or disconnecting cabin unit U based on the command generated by the task control unit 1044. The second driving unit 111 may include a hydraulic mechanism or motor for an actuation, such as a connecting mechanism.

The communication unit 112 has a communication unit for connecting the running unit 100A to the network N. In the present embodiment, the running unit 100A can communicate with other apparatuses, for example, the server apparatus 200 via the network N. The running unit 100 A can also communicate with the user equipment 300 via the network N. The communication unit 112 may further include a communication device for enabling running unit 100A, which is the own vehicle, to perform inter-vehicle communication with the other running unit 100 (100B.).

The displaying unit 116 is, for example, a liquid crystal display, an electroluminescent panel or the like. The displaying unit 116 can display information such as data acquired from the server device 200 via the information acquisition unit 1041. For example, the displaying unit 116 is used at the center C to instruct the loading of items to the operator in charge of the loading operation of items to cabin unit U connected to running unit 100A.

The operating unit 118 is, for example, a switch button, a keyboard, a pointing device, or the like, and can be operated by an operator in charge of loading items. The operating unit 118 is used, for example, to enter the completion of the loading of items when it is completed. Here, the image acquiring unit 1045 operates based on the input of the completion of items loading from the operation unit 118. The operating unit 118 includes a touch panel and may be substantially integrated with the displaying unit 116.

The operating unit 118 also serves as an entry for obtaining the identity information of an item upon loading of the item into cabin unit U connected to running unit 100A. For example, the operating unit 118 has a bar code or QR-code reading function. The operating unit 118 may include a reader/writer of a RFID (a system for reading and writing data of RF tags using radio waves in a contactless manner). In this instance, the RF-tag may be attached to the item. It is noted that the input unit for acquiring the identification information of an item may be separated from the operation unit 118.

Next, the server device 200 will be described. The server apparatus 200 is an apparatus that provides information of various operation commands to each of the plurality of running units 100.

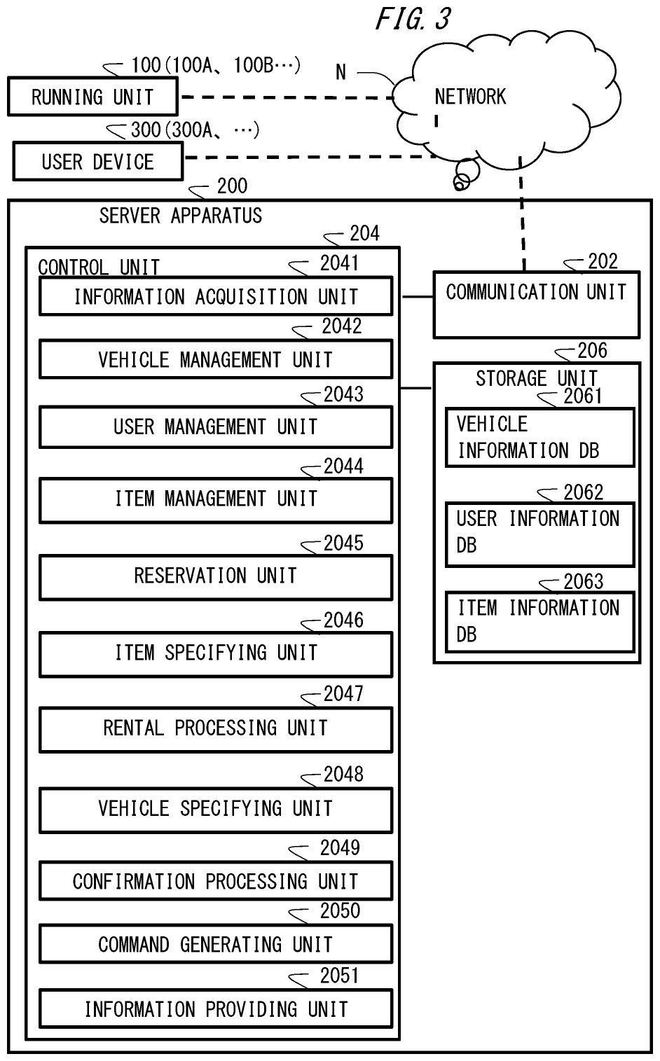

The server device 200 is information processing apparatus and is configured with a communication unit 202, a control unit 204, and a storage unit 206 as shown in FIG. 3. The communication unit 202 is similar to the communication unit 112, and has a communication function for connecting the server device 200 to the network N. The communication unit 202 of the server apparatus 200 is a communication interface for communicating with the running unit 100 and the user apparatus 300 via the network N. The control unit 204 includes a CPU and a main storage unit in the same manner as the control unit 104, and executes information processing by programs. Of course, this CPU is also a processor, and the main storage unit of control unit 204 is also an example of a main storage device. The CPU in the control unit 204 executes a computer program that is executably expanded in the main storage unit and provides various functions. The main storage unit in control unit 204 stores a computer program and/or data executed by the CPU. The main storage unit in the control unit 204 is a DRAM, SRAM, a ROM, or the like.

The control unit 204 is connected to the storage unit 206. The storage unit 206 is an external storage unit, which is used as a storage area for assisting the main storage unit of control unit 204, and stores computer programs and/or data to be executed by the CPUs of the control unit 204. The storage unit 206 may be hard disk drives, SSDs, etc.

The control unit 204 is a unit for controlling the server apparatus 200. As shown in FIG. 3, the control unit 204 includes, as functional modules: an information acquisition unit 2041; a vehicle management unit 2042; a user management unit 2043; an item management unit 2044; a reservation unit 2045; an item specifying unit 2046; a rental processing unit 2047; a vehicle specifying unit 2048; a confirmation processing unit 2049; a command generating unit 2050; and an information providing unit 2051. These functional modules are realized by executing a program stored in the main storage unit and/or the storage unit 206 by the CPU of the control unit 204.

The information acquisition unit 2041 acquires various information from running unit 100 and the user device 300. Then, the acquired information is transmitted to the vehicle management unit 2042, the user management unit 2043, the item management unit 2044, or the like. The information acquisition unit 2041 periodically acquires, for example, location information and information stored in own-vehicle-information database 1141 from running unit 100, and transmits them to the vehicle management unit 2042. Further, the information acquisition unit 2041 obtains information of the registered user or information entered by the user from the user device 300 associated with the user and sends it to the user management unit 2043. When the information acquisition unit 2041 acquires information of the user's item through the user device 300 of the registered user, the information acquisition unit 2041 sends it to the item management unit 2044. In addition, the information acquisition unit 2041 acquires response when the confirmation processing unit 2049, which will be described later, interrogates (for example, sending confirmation request) the user equipment 300, and transmits the response to the confirmation processing unit 2049.

The vehicle management unit 2042 manages information of several managed running unit 100. Specifically, the vehicle management unit 2042 receives information such as data relating to the running unit 100 from a plurality of running unit 100 via the information acquisition unit 2041, and stores the data in the vehicle information data base 2061 of the storage unit 206. The position information and the vehicle information are used as information for the running unit 100. The vehicle information is, for example, identifiers of the running unit 100, use and type, information on standby points, available running distances, present statuses, etc. The present status includes the type of tires, the availability of running unit 100, and the like. The vehicle management unit 2042 also stores the position information and the unit information of the cabin unit U in the vehicle information data base 2061 of the storage unit 206. The position information of the cabin unit U may be information of the position of the connections and/or disconnections from running unit 100. The unit information of cabin unit U includes the sizes, capacity, etc. of the cabin unit U, and can be obtained here by inputs from the operator's working terminal or the user device 300.

The user management unit 2043 stores the user's information in the user information database 2062 of the storage unit 206. When information from a user (for example, the user's schedule information) is retrieved via information acquisition unit 2041, user management unit 2043 stores the information in the user information database 2062. The user information database 2062 stores user information. The user information includes a user-specific identity information (for example, a user identity, a contact, and so on).

The item management unit 2044 manages information of items (deposit items) deposited by the user. Information of the deposit items can be retrieved by a user-specific identity information (e.g., user ID) and is stored in the item information database 2063 of storage unit 206, which is at least searchable by a use. In the item information data base 2063, item identification information (for example, item IDs) is attached to the respective item (item of goods), and the item can be searched for by the item identification information. For example, an operator may be able to locate an item with its item identification information, and an item transporting apparatus may be able to locate and transport an item with its item identification information.

The reservation unit 2045 accepts information of reserving utilization of the vehicle from the user. In this reception, for example, a purpose of the use reserving utilization of the vehicle is acquired. For example, when a user's schedule is stored in the user device 300, the schedule information is supplied to the server device 200 through the user device 300 and stored in user information database 2062. The schedule information is that of a registered user and contains information of reserving utilization of vehicles. Alternatively, if the user enters information of reserving utilization of a vehicle via his or her user device 300, information of reserving utilization is transmitted to the server device 200 via his or her user device 300. Information of reserving utilization includes information of a purpose of the user, and may include, for example, information of “travel” or “business trip”. However, reservation unit 2045 may acquire a purpose of the user corresponding to a destination location of the move. For example, if “inn”, “hotel” or the like is set as a destination in schedule information or information of reserving utilization of the vehicle, reservation unit 2045 may acquire “travel” as a purpose of the user. If the company name is set as a destination in the schedule information or the information of reserving utilization of the vehicle, the reservation unit 2045 may acquire the “business” as a purpose of the user. When a meeting place or the like is set as a destination in the schedule information or the information of reserving utilization of the vehicle, the reservation unit 2045 may acquire “meeting” as a purpose of the user. The reservation unit 2045 may obtain a purpose of the user corresponding to a destination of the route guidance when the route guidance is requested together with inputting information of reserving utilization of the vehicle. That is, when “inn”, “hotels” and the like are set as the destination of the route guidance, the reservation unit 2045 may acquire “travel” as purpose of the user. The reservation unit 2045 also serves to initiate the process of providing the vehicle to the user based on the various information identified during reserving utilization of the vehicle from the user, as will be described later.

The item specifying unit 2046 specifies an item of use that matches the obtained purpose of a user from deposit items to be managed. The identifying this item is done in items associated with the user himself or herself. From at least one deposit items from the user who has made reserving utilization of the vehicle, an item of a use “travel” that matches the acquired purpose of the user is identified when the item of the use is identified, e.g., when purpose of the user is “travel”. This identification is performed by searching the item information data base 2063 by purposes or uses. The server device 200 may include the search dictionary data that defines the relationship between purpose of a user and use, or may be able to utilize search dictionary data.

When a request or a response from a first user includes a request for an item other than deposit items B deposited from the first user, the rental processing unit 2047 identifies the item for rental that matches the request from among other deposit items deposited from second users other than the first user. For example, if there is a request from a user reserving utilization to item of the “barbecue” use, but the user's deposit items does not have any item of the use, rental processing unit 2047 specifies items of the use from among other deposit items of other users. When the item can be identified in deposit items of another user, the rental processing unit 2047 executes a process of lending the item (also referred to as a rental process). For example, the rental processing unit 2047 executes a process for giving predetermined privileges, such as giving points according to the rental, to another user. It should be noted that the privileges may be usable for the provision of services in the present system S.

Vehicle specifying unit 2048 identifies the vehicles to be assigned to the user in response to a use that meets purpose of the user reserving utilization of the vehicle. For example, the vehicle specifying unit 2048 identifies vehicles according to the sizes of the item identified in the item specifying unit 2046. The item information database 2063 also stores size information of each item. Based on the size information, the vehicle information data base 2061 is searched to identify vehicles suitable for loading the identified item. Here, identifying a vehicle suitable for carrying a particular item is directed to identifying an appropriate cabin unit U from among several sizes of cabin units Us. Further, one running unit 100 may be selected from among various sizes of running unit 100 to match the size of cabin unit U.

The vehicle specifying unit 2048 identifies a running unit 100 to assign to a user according to a use that conforms to purpose of the user reserving utilization, among a plurality of running unit's 100. In this specification of running unit 100, the vehicle information data base 2061 is also used. For example, when the user's purpose of movement is skiing, running unit 100 with the snow tire is selected.

The confirmation processing unit 2049 performs a verification process for the user at various stages. For example, when item specifying unit 2046 identifies an item, it performs a process to provide the user device 300 of the user with images of information of the item, e.g., an item, to obtain a confirmatory response from the user. This may also be performed when: the rental processing unit 2047 identifies the item; the vehicle specifying unit 2048 identifies the vehicle; and/or the item is loaded into the vehicle identified in the vehicle specifying unit 2048. The images according to the camera 107 above can be used to verify the loaded item when loading item onto the vehicles specified in the vehicle specifying unit 2048. When some or all of the checking processes are completed, the confirmation processing unit 2049 can providing information (for example, reservation completion information) indicating that the vehicle loaded with the specified item is usable to the user.

The command generating unit 2050 generates an operation command that includes a running plan of the vehicles identified based on information of the user's reserving utilization. For example, when the destination of the vehicle is the user's home in the user's reserving utilization, the running plan is generated as the control information of the automated driving of the vehicle, i.e., running unit 100, to the user's home. The running plan may include: information of a destination, time of arrival at the destination, and/or scheduled utilization end time by the user, etc.

The information providing unit 2051 provides or sends an operation command to the predetermined running unit 100, including the running plan generated by command generating unit 2050. When transmitting to the running unit 100, the vehicle information data base 2061 is referred to. The information providing unit 2051 also provides the user equipment 300 with verification information or the like generated by the confirmation processing unit 2049. When providing information to the user device 300, the user information database 2062 is referred to.

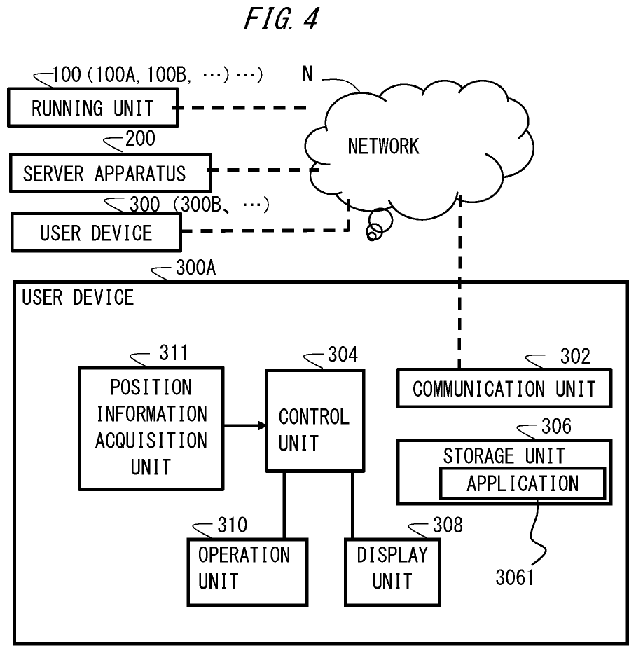

Next, the user device 300 will be described. The user device 300 is, for example, a mobile terminal, a smart phone, a personal computer, or the like. The exemplary user device 300A of FIG. 4 includes a communication unit 302, a control unit 304, and a storage unit 306. The communication unit 302 and storage unit 306 of the user device 300A are the same as communication unit 202 and storage unit 206 of the server device 200, respectively. Further, the user device 300A includes a display unit 308, an operation unit 310, and a position information acquisition unit 311. The display unit 308 is, for example, a liquid crystal display, an electroluminescent panel or the like. The operation unit 310 may be, for example, a keyboard, a pointing device, or the like. More specifically, in the present embodiment, the operation unit 310 includes a touch panel and is substantially integrated with the display unit 308. The position information acquisition unit 311 has the same configuration as the position data acquiring unit 108, and sends the location information to control unit 304.

The control unit 304 includes CPUs and a main storage unit, similarly to the control unit 204 of the server device 200. The CPU of the control unit 304 executes the application program (application) 3061 stored in storage unit 306. The application 3061 is an application program for accessing information delivered from a web server or server device 200. The application 3061 has a GUI, accepts input from the user, and transmits the GUI to the server device 200 via the network N. Through the user device 300, the user can provide the server device 200 with information of reserving vehicles, information of registering deposit items, a response to a confirmation request sent from the server device 200, and the like.

In FIG. 2, FIG. 3, and FIG. 4, the running unit 100, the server apparatus 200, and the user apparatus 300 are connected via the same network N. However, this connection may be realized by a plurality of networks. For example, the network connecting running unit 100 and the server apparatus 200 and the network connecting the server apparatus 200 and the user apparatus 300 may be different networks.

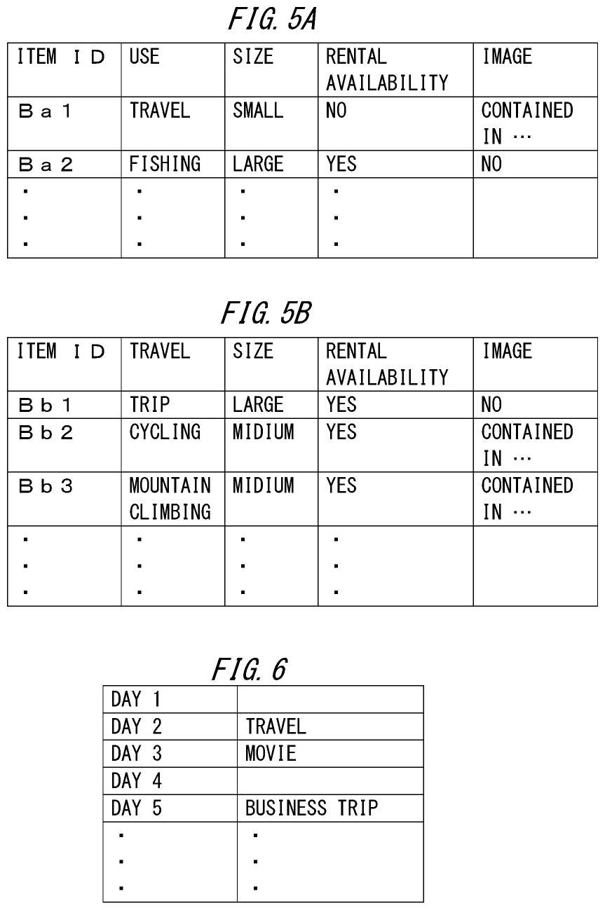

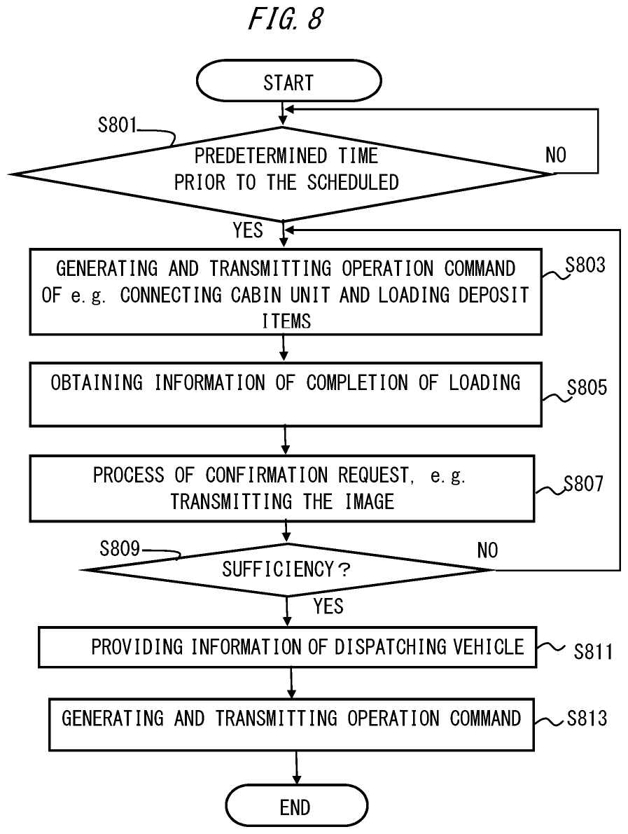

Here, the processing in the system S having the above configuration will be described with reference to FIGS. 5 to 8 with reference to FIG. 1. First, item information database 2063 will be described with reference to FIG. 5.

FIG. 5A and FIG. 5B illustrate two pages in item information database 2063. The page of FIG. 5A is a page searchable by the user A's identity information, and includes information of deposit items Ba (Ba1, Ba2.). The page of FIG. 5B is a page searchable by the identity information of the user B, and includes information of deposit items Bb (Bb1, Bb2, Bb3.). The item information database 2063 contains item ID as item ID information, and use, size, rental availability, and item of the ID. From the user device 300, the user can rewrite his or her own data of the item information database 2063. For example, when item management unit 2044 of the server device 200 sets a use of item Ba2 of the user A to “hiking”, the user A can rewrite the use to “fishing”. Here, the respective users can browse not only information of their own deposit items but also information of deposit items of other users via the user device 300. In addition, the user can refer to information of deposit items via the user device 300 and enter the reserving information of the vehicle.

FIG. 6 shows a portion of schedule information (e.g., calendars) stored in the user device 300A of user A. The user device 300A sends this schedule information to the server device 200, and the user management unit 2043 of the control unit 204 of the server device 200 can store the schedule information in the user information database 2062. The reservation unit 2045 of the control unit 204 of the server device 200 can also read a part or all of this schedule information as a reserved information for obtaining.

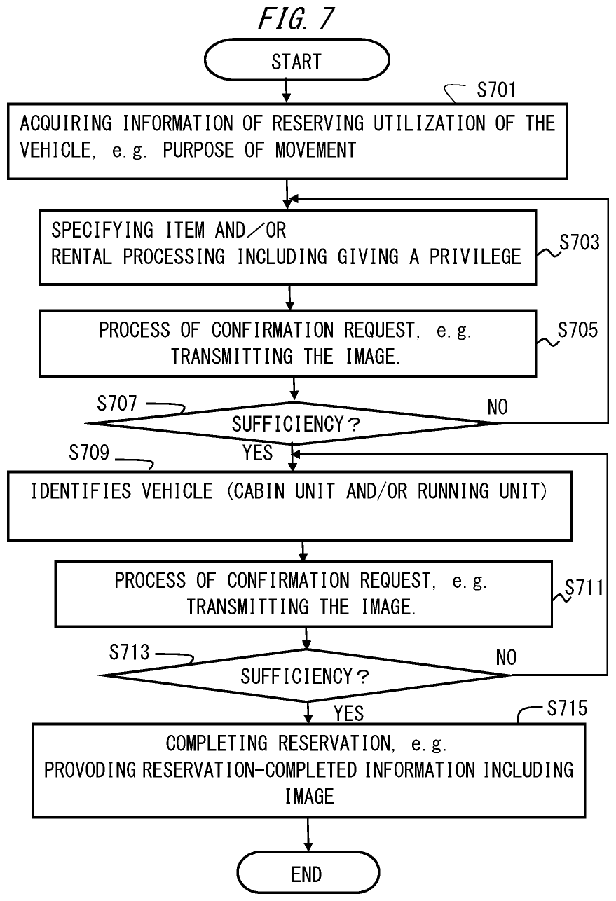

Next, a process performed when the user A inputs information of reserving utilization of the vehicle from the user device 300A will be described with reference to FIG. 7.

When the information acquisition unit 2041 of the control unit 204 of the server apparatus 200 acquires information (reservation information) of reserving utilization of the vehicle of the user A via the user apparatus 300A, the server apparatus 200 transmits the acquired reservation information to reservation unit 2045. The information of reserving utilization of the vehicle includes purpose of the user along with time information such as the dispatch date and time. Accordingly, reservation unit 2045 acquires purpose of the user reserving utilization of the vehicle (step S701). Purpose of the user is, for example, “travel”, “business trip”, or the like. For example, the reservation unit 2045 may obtain “travel” as the second day's purpose of the user (see FIG. 6) based on user A's schedule information in the user information database 2062.

The item specifying unit 2046 of the control unit 204 of the server device 200 specifies an item of a use that matches the acquired purpose of the user from the plurality of deposit items deposited from the user A (step S703). It should be noted that only one item may be deposited from the user A. When the purpose of the user is, for example, “Travel” or “Business Trip”, the item specifying unit 2046 first extracts use “Travel” as a use that matches purpose of the user. This is done by retrieving the search dictionary data that defines the relationship between a purpose of a user and a use, as described above. Then, the item specifying unit 2046 searches the pages (information) of the user A in the item information database 2063 of FIG. 5A with the user's identity information and its use. The item specifying unit 2046 specifies item Ba1 from deposit items Ba (Ba1, Ba2.) of the user A (step S703). At this time, since response for confirmation request to the user A has not yet been received from the user A, the rental processing by the rental processing unit 2047 is not executed, and the processing in step S703 ends.

When an item is specified, the confirmation processing unit 2049 of the control unit 204 of the server apparatus 200 executes a process of providing a confirmation request for confirming the specified item Ba1 to the user A via the user apparatus 300A (step S705). This means that the user device 300A of the user A is notified that “item Ba1” has been specified as an item to be loaded on the vehicle, that is, as the item of the use that conforms to purpose of movement of the reservation information of the user A, and inquires as to whether the items loaded on the vehicle is all. For example, if there is image data of the specified item Ba1, confirmation request may include the image data. Here, as shown in FIG. 5A, since the server apparatus 200 has the image of item Ba1, the confirmation request of the server apparatus 200 includes the image of item Ba1.

The user A can confirm the content of confirmation request via the user device 300A and enter a response for it. When an item to be loaded on the vehicle is only item Ba1, the user A can enter a response indicating that the item is sufficient. The user A can also enter a response to that effect when he/she wishes to an item as another item to be loaded on the vehicle, which differs from item Ba1, and/or when he/she wishes to make other item in addition to item Ba1. For example, if User A climbs to a mountain while purpose of the user is a trip, User A may include in response requests for an item of a use “climb”. Here, a process performed when the confirmation processing unit 2049 of the control unit 204 of the server apparatus 200 accepts the response including the request for an item of a use “climbing” as a response from the user A will be exemplified. When confirmation processing unit 2049 receives such a response, since the item to be loaded on the vehicle is not only item Ba1 (negative determination in step S707), the response is transmitted to the item specifying unit 2046 in order to specify a further item.

The item specifying unit 2046 sends its requests to the rental processing unit 2047 when the user A's deposit items do not include an item of a use “climb”. The rental processing unit 2047 identifies at least one deposit items for rental that meets its requirements from at least one deposit items from a user other than user A. Deposit items Bb of the user B has an item Bb3 of the use “climbing mountains”. Therefore, rental processing unit 2047 specifies deposit items Bb3 of the user B as an item for rental in addition to the item Ba1 (step S703). At this time, rental processing unit 2047 gives a predetermined privilege (benefit) to the user B in consideration of the rental of item Bb3 to the user A. This privilege may be determined by considering the value, useful life, and/or rental duration of item Bb3. For example, the privileges may be service utilization tickets of system S, or may be a reduction in the administrative cost of user B's deposit items. Further, the rental utilization fee or the service utilization fee according to utilization frequency of the rental may be assigned to the user A who rents the service.

The confirmation processing unit 2049 of the control unit 204 of the server device 200 executes the process of confirmation request of item Bb3 specified for rental in the same manner as in the case of the specified item Ba1 (step S705). In response to this confirmation request, when confirmation processing unit 2049 obtains a response from the user A indicating that items to be loaded on the vehicle completed by item Ba1 and item Bb3 (affirmative determination in step S707), confirmation processing unit 2049 transmits information of the item to vehicle specifying unit 2048.

The vehicle specifying unit 2048 identifies vehicles (step S709). In this case, the identifying is executed for the vehicles to be assigned to the user A in response to the above-mentioned use, i.e., the use “travel” and the use “climbing” that conform to the acquired purpose of the user. More specifically, since the vehicle includes a running unit 100 that separably connects cabin unit U, the steps that identify the vehicle include a step that identifies a cabin unit U and a step that identifies a running unit 100. For example, utilization fees of the specified cabin unit and/or running unit may vary depending on utilization frequency of the user A.

The identification of the cabin unit U is performed according to the sizes of the identified items Ba1 and Bb3. According to FIG. 5, item Ba1 is of small size and item Bb3 is of medium size. Therefore, according to predetermined programs, the vehicle specifying unit 2048 can estimate that the item size obtained by combining these items Ba1 and Bb3 is a large size. The vehicle specifying unit 2048 searches for the vehicle information data base 2061 on the storage unit 206. The vehicle specifying unit 2048 can specify a cabin unit UA from among the unreserved cabin units Us at the delivery date and time of the vehicle reservation. The cabin unit UAs specified here are cabin unit classified into large sizes. The specified cabin unit may be fixed to the user A.

The identification of a running unit 100 is performed in response to the acquired purpose of the user or use described above that is compatible with purpose of the user. The vehicle specifying unit 2048 identifies a running unit 100A with snow tires as the running unit that conforms to the use “travel” and the use “mountain climbing” at the time and date of delivery of the vehicle appointment in accordance with predetermined programs. Here, the dispatch date and time of the reservation of the vehicle is the winter time.

When the vehicle is specified in this manner, the process of confirmation request of the specified vehicle is executed (step S711). This confirmation request process is executed in the same manner as in the specified item Ba1 by the confirmation processing unit 2049 of control unit 204 of the server device 200. In this confirmation request, user A is provided with information on the specifications of the specified vehicles, e.g., types of tires. In response to this confirmation request, when a negative response is obtained from the user A (negative determination is made in step S713), the confirmation processing unit 2049 transmits a signal to instruct the vehicle specifying unit 2048 to specify a different vehicle. At this time, requests from the user A may be provided to vehicle specifying unit 2048.

When a positive response is obtained from the user A for this confirmation request (affirmative determination in step S713), the confirmation processing unit 2049 provides the user device 300A of the user A with a reservation-completed information (step S715). That is, the confirmation processing unit 2049 provides the user equipment 300A of the user A with information indicating that the vehicle loaded with the specified items Ba1 and Bb3 (here, running unit 100A connected to cabin unit UA) can be turned utilization with respect to reserving utilization of the vehicle from the user A. The information here includes images of the specified item Ba1 and the like loaded on the vehicles. The provision of this information is performed via the information providing unit 2051. Thus, the provided information is stored in the user information database 2062. Information about the cabin unit UA and the running unit 100A is also stored in vehicle information data base 2061. The same applies to the items Ba1 and Bb3 in item information database 2063.

The reservation unit 2045 of control unit 204 of the server device 200 acquires information of reserving utilization of the vehicle from the user A stored in user information database 2062 or the like in this manner at a date and time which is a predetermined time prior to the scheduled delivery date and time (affirmative determination in step S801). Thus, the reservation unit 2045 causes the confirmation processing unit 2049 to execute the verification process in order to initiate the process of providing vehicles to the user A.

First, confirmation processing unit 2049 causes the command generating unit 2050 to generate an operation command to the specified running unit 100A. This operation command includes a running plan for having the running unit 100A perform the process of connecting the cabin unit UA and loading deposit items Ba1 and Bb3 in its cabin. The generated operation command is transmitted to the running unit 100A via the information providing unit 2051 (step S803).

In the running unit 100, when an operation command is received, a running plan is generated by the plan generation unit 1042. This allows the running unit 100 to connect the cabin unit UA while moving. Then, in the running unit 100, information of the items Ba1 and Bb3 to be loaded into the cabin unit UA is displayed on the displaying unit 116 so that they can be seen by the operator. This allows the operator to load the items Ba1 and Bb3 into the cabin unit UA. The image acquisition unit 1045 of control unit 104 of running unit 100 A is activated when accepting an input from operating unit 118 by the operator (e.g., when the loading complete button is pressed), and acquires an image of the items in cabin unit UA from camera 107. The image acquisition unit 1045 stores the acquired image in the own-vehicle-information database 1141, and provides the server apparatus 200 with the image attached to information indicating the completion of loading via the information provision unit 1046. The information of the loading complete may include information of the items acquired via operating unit 118 of running unit 100A.

When the information of completion of loading is thus obtained (step S805), the confirmation processing unit 2049 of control unit 204 of the server device 200 executes the process of a confirmation request of the vehicle loaded with the specified items Ba1 and Bb3 (step S807). This confirmation request process is executed in the same manner as in the specified item Ba1 by confirmation processing unit 2049 of control unit 204 of the server device 200. In this confirmation request, images in the cabin unit UA connected to running unit 100A are provided to the user A. In response to this confirmation request, when a negative response is obtained from the user A (negative determination is made in step S809), the server apparatus 200 returns to step S803, and the confirmation processing unit 2049 of the server apparatus 200 generates and transmits a command for reconfirmation to the running unit 100A. At this time, the operator who has received the command via displaying unit 116 of running unit 100A can obtain the contact address (e.g., telephone number) of the user A by communicating with his/her own user apparatus or the like and the server apparatus 200, and obtain the instruction of the user A.

Assume that the confirmation processing unit 2049 obtains a positive response from user A for confirmation request in step S807 (affirmative determination in step S809). Then, the confirmation processing unit 2049 provides the user device 300A with information to dispatch the vehicle to the user A, which is a reserving target reserved by the user A (step S811). Here, the information to dispatch the vehicle includes, for example, the scheduled arrival place (the dispatch place) and the scheduled arrival time. The scheduled arrival location and the scheduled arrival time generally correspond to the position information and the time information included in the information of reserving utilization of the vehicle from the user A, respectively.

The confirmation processing unit 2049 then causes the command generating unit 2050 to generate an operation command containing the travel plans to the running unit 100A. The generated operation command is provided to the running unit 100A via information providing unit 2051 (step S813). As a result, as shown by a broken line in FIG. 1, the running unit 100A can be moved or dispatched to the user A (here, to the home HA of the user A) with the items Ba1 and Bb3 loaded on the connected cabin unit UA.

As described above, according to the processing by the control unit 204 of the server device 200 of the present system S, the above-described processing is preferably executed, and the dispatch of the vehicle is executed. Therefore, the convenience of the vehicle lending service of the present system S can be enhanced.

The above embodiment is merely an example, and the scope disclosure may be appropriately modified and practiced without departing from the gist thereof. The processing and/or means described in the present disclosure can be carried out either partially or freely in combination, provided that technical inconsistencies do not occur.

For example, in the above embodiment, when the vehicle is specified (step S709), both a cabin unit and a running unit are specified according to purpose of the user reserving utilization of the vehicle. However, there may be cases where at least one of a cabin unit and a running unit is a user's possession. The provision of the vehicle rental service of the system S can be variously changed so as to flexibly cope with such a situation.

Furthermore, a process that is described to be performed by one apparatus may be shared and performed by a plurality of apparatuses. For example, the server device 200, which is information processing apparatus, and/or information processing apparatus 102 of running unit 100 need not be a single computer, but may be configured as a system including a plurality of computers. Processes described to be performed by different apparatuses may be performed by one apparatus. Which function is to be implemented by which hardware configuration in a computer system may be flexibly changed.

The disclosure may also be implemented by supplying computer programs for implementing the functions described above in the embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller, the controller configured to perform:
a step of obtaining a purpose of a user reserving utilization of a vehicle from the user;
a step of specifying, from at least one of the deposit items deposited from the user, an item of a use that matches the obtained purpose of the user; and
a step of providing information to the user indicating that the vehicle to be assigned to the user and loaded with the specified item is available.

2. The information processing apparatus according to claim 1, wherein the controller is accessible to a database configured to be searchable at least by a use per item for at least one of deposit items.

3. The information processing apparatus according to claim 1, wherein the information comprises an image of an item loaded on the vehicle.

4. The information processing apparatus according to claim 1, wherein the controller further performs:
a step of providing a confirmation request for confirming the specified item to the user; and
a step of obtaining a response for the confirmation request from the user.

5. The information processing apparatus according to claim 4, wherein the confirmation request comprises an image of the item loaded on the vehicle.

6. The information processing apparatus according to claim 4, wherein the controller further executes a step of specifying for rental, another item that matches a further request from at least one of other deposit items deposited from another user other than the user when the obtained response includes the further request for another item other than the deposit items deposited from the user.

7. The information processing apparatus according to claim 6, wherein the controller further performs a step of giving a predetermined benefit to the another user who has deposited the another item specified for rental.

8. The information processing apparatus according to claim 1, wherein the controller further performs a step of specifying the vehicles to be assigned to the user in response to the obtained purpose of the user or the use that matches the purpose of the user.

9. The information processing apparatus according to claim 8, wherein the vehicle includes a cabin unit capable of loading the specified item and a running unit detachably connecting the cabin unit, and wherein the step of specifying the vehicle includes a step of specifying the cabin unit.

10. The information processing apparatus according to claim 9, wherein the step of specifying the cabin unit is performed according to a size of the specified item.

11. The information processing apparatus according to claim 8, wherein the vehicle includes a running unit for detachably connecting a cabin unit capable of loading the identified item, and the step of specifying the vehicle includes a step of specifying the running unit in response to the obtained purpose of the user or the use that matches the purpose of the user.

12. The information processing apparatus according to claim 1, wherein the controller further performs a step of obtaining purpose of the user or a use that matches the purpose of the user from the user's schedule information.

13. An information processing method executed by at least one computer, comprising:
a step of obtaining a purpose of a user reserving utilization of a vehicle from the user;
a step of specifying, from at least one of the deposit items deposited from the user, an item of a use that matches the obtained purpose of the user; and
a step of providing information to the user indicating that the vehicle to be assigned to the user and loaded with the specified item is available.

14. The information processing method according to claim 13, wherein the at least one computer is accessible to a database configured to be searchable at least by a use per item for at least one of the deposit items.

15. The information processing method according to claim 13, further comprising:
a step of providing confirmation request for confirming the specified item to the user; and
a step of acquiring a response for the confirmation request from the user.

16. The information processing method according to claim 15, further comprising a step of specifying, for rental, another item that matches a further request from among at least one of other deposit items deposited from another user other than the user, when the obtained response includes the further request for another item other than the deposit items deposited from the user.

17. The information processing method according to claim 16, further comprising a step of giving a predetermined benefit to the another user who has deposited the another item specified for rental.

18. The information processing method according to claim 13, further comprising a step of specifying a vehicle to be assigned to the user in response to the obtained purpose of the user or the use that matches the obtained purpose of the user.

19. The information processing method according to claim 18, wherein the vehicle includes a running unit for detachably connecting a cabin unit and the cabin unit capable of loading the specified item; and
the step for specifying the vehicle includes a step of specifying the cabin unit.

20. A computer-readable non-transitory recording medium recording a program that causes at least one computer to perform:
a step of obtaining a purpose of a user reserving utilization of a vehicle from the user;
a step of specifying, from at least one of the deposit items deposited from the user, an item of a use that matches the obtained purpose of the user; and
a step of providing information to the user indicating that the vehicle to be assigned to the user and loaded with the specified item is available.
